(19) United States
(12) Patent Application Publication
(10) Pub. No.: US 2007/0225030 A1
(43) Pub. Date: Sep. 27, 2007

(54) ELECTRONIC EQUIPMENT WITH PERSONALIZED CALL HOLDING

(76) Inventor: Les TEAGUE, Berkshire (GB)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/277,529

(22) Filed: Mar. 27, 2006

(51) Int. Cl. H04M 1/00

(52) U.S. Cl. 455/550.1; 455/414.1

(57) ABSTRACT

An electronic equipment includes call circuitry that enables the electronic equipment to establish a call with a called/calling device, and hold circuitry that enables the electronic equipment to place the call established with the called/calling device on hold. The electronic equipment further includes a media player and a controller operative in conjunction with the call circuitry, hold circuitry and media player, to communicate a media object to the called/calling device when the call is placed on hold.

### TECHNICAL FIELD OF THE INVENTION

The present invention relates generally to electronic equipment, and more specifically to electronic equipment with personalized call features for use within a communications network.

### DESCRIPTION OF THE RELATED ART

Electronic equipment such as portable electronic devices have been popular for decades, and yet continue to increase in popularity. In the communications area, advances in electronic equipment such as digital telephones, mobile phones, pagers, communicators, electronic organizers, personal digital assistants (PDAs), smartphones, etc. have made it possible for seemingly everyone to own one or more different devices.

In fact, users are increasingly viewing electronic equipment such a mobile phones, etc., as an item of preference. Many different types of electronic equipment today allow the user to customize their experience using the electronic equipment. For example, the user of a mobile phone may select particular wallpapers, screen savers, ring tones, banners, casing colors, etc. Each selection further customizes the mobile phone to the likes and preferences of the user. The mobile phone has therefore increasingly become an extension of the user's own personality.

Despite such past improvements in the user's ability to customize his or her experience, there still have been limitations. For example, the user's selection of wallpaper, ring tone, banners, casing color, etc., personalizes a mobile phone from the perspective of the user. However, such selections do little to share or extend the user's personality with a called or calling device on another end of a call involving the user's mobile phone. The called or calling device is unable to see or hear the user's wallpaper selection, ringtone, etc.

In view of the aforementioned shortcomings associated with existing electronic equipment such as mobile phones, there is a strong need in the art for electronic equipment that personalizes the user even with respect to a called/calling device at the other end of a call.

### SUMMARY

According to an aspect of the invention, an electronic equipment includes call circuitry that enables the electronic equipment to establish a call with a called/calling device, and hold circuitry that enables the electronic equipment to place the call established with the called/calling device on hold. The electronic equipment further includes a media player and a controller operative in conjunction with the call circuitry, hold circuitry and media player, to communicate a media object to the called/calling device when the call is placed on hold.

According to another aspect of the invention, the media player streams the media object to the called/calling device.

In accordance with another aspect of the invention, the media player reproduces the media object as an audio signal when communicating the media object to the called/calling device.

According to yet another aspect, the electronic equipment further includes a library of media objects, and the controller enables a user to select from the library the media object communicated to the called/calling device.

In accordance with still another aspect, the electronic equipment further includes a library of media objects, and the controller communicates the media object selected from among the library of media objects as a function of an identity of the called/calling device.

According to another aspect of the invention, the electronic equipment further includes a library of media objects, and the controller communicates the media object selected generally randomly from among the library of media objects.

In accordance with another aspect, wherein the media object comprises an audio object.

According to still another aspect, the media object comprises a visual object.

In yet another aspect, the media object represents an advertisement.

According to another aspect of the invention, an electronic equipment is provided that includes call circuitry that enables the electronic equipment to establish a call with a called/calling device and hold detection circuitry that enables the electronic equipment to detect if the call established with the called/calling device has been placed on hold. In addition, the electronic equipment includes a media player, at least one of an audio output and a display, and a controller. The controller is operative in conjunction with the call circuitry, hold detection circuitry and media player to reproduce a media object via the at least one of the audio output and the display when the call is detected as having been placed on hold.

In accordance with another aspect, the electronic equipment further includes a library of media objects, and the controller enables a user to select from the library the media object which is reproduced.

In accordance with still another aspect, the electronic equipment further includes a library of media objects, and the controller selects the media object that is reproduced from among the library of media objects as a function of an identity of the called/calling device.

In yet another aspect, the electronic equipment further includes a library of media objects, and the controller selects the media object which is reproduced generally randomly from among the library of media objects.

According to still another aspect of the invention, a computer program stored on a machine-readable medium is provided for use in conjunction with an electronic equipment including call circuitry that enables the electronic equipment to establish a call with a called/calling device; hold circuitry that enables the electronic equipment to place the call established with the called/calling device on hold; and a media player The computer program upon execution by a controller is operative in conjunction with the call circuitry, hold circuitry and media player to at least one of communicate a media object to the called/calling device when the call is placed on hold, and reproduce a media object via at least one of an audio output and a display when the call is detected as having been placed on hold.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1A is a perspective view of an exemplary mobile phone in accordance with an embodiment of the present invention;

FIG. 1B is a perspective view of an exemplary mobile phone representing a called/calling device in accordance with an embodiment of the present invention;

FIG. 1C is a perspective view of an exemplary mobile phone representing a called/calling device in accordance with another embodiment of the present invention;

FIG. 1D is a perspective view of an exemplary mobile phone representing a called/calling device in accordance with still another embodiment of the present invention;

FIG. 2 is a block diagram of an exemplary mobile phone in accordance with an embodiment of the present invention;

FIGS. 3A, 3B and 3C represent exemplary displays on the mobile phone of FIG. 2 for selecting personalized caller hold functions in accordance with an embodiment of the present invention;

FIG. 4 is an exemplary flowchart suitable for programming a mobile phone to provide personalized call holding to a called/calling device in accordance with the present invention; and

FIG. 5 is an exemplary flowchart suitable for programming a mobile phone to provide personalized call holding internally in accordance with the present invention

### DETAILED DESCRIPTION OF EMBODIMENTS

The present invention will now be described with reference to the drawings, wherein like reference numerals are used to refer to like elements throughout.

The term “electronic equipment” as referred to herein includes various types of communication equipment such as conventional public switched telephone network (PSTN) equipment (e.g., land phones, etc.) as well as portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like. In the present application, the invention is described primarily in the context of a mobile phone communications network. However, it will be appreciated that the invention is not intended to be limited to a mobile phone communications network. The present invention relates to any type of electronic equipment within a corresponding communications network.

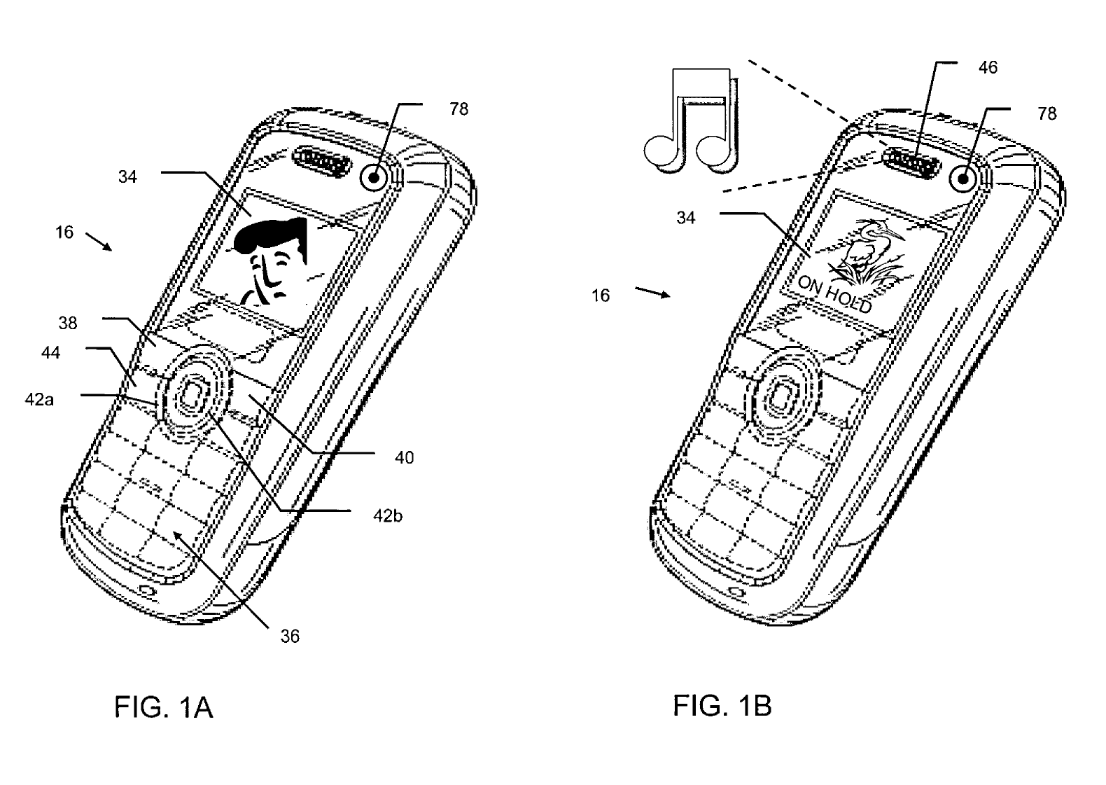

FIG. 1A illustrates a mobile phone 16 in accordance with the present invention. The mobile phone 16 as described herein can represent both a user mobile phone 16 in accordance with the present invention, or a called or calling mobile phone 16 between which a call with the user mobile phone 16 is established. Those having ordinary skill in the art will find it readily apparent from the context of the description provided herein whether the mobile phone 16 is being referred to as a user mobile phone 16 or a called/calling device mobile phone 16. Moreover, although the mobile phone 16 of the present invention may have the features described herein, those with ordinary skill will be appreciate that the called/calling device mobile phone 16 need not necessarily have the same features. A single type mobile phone is described herein merely for convenience.

The mobile phone 16 as shown in FIG. 1A has a “brick” or “block” design type housing, but it will be appreciated that other type housings such as clamshell or slide-type housings may be utilized without departing from the scope of the invention.

The mobile phone 16 includes a display 34 and keypad 36. As is conventional, the display 34 displays information to a user such as operating state, time, phone numbers, contact information, various navigational menus, etc., which enable the user to utilize the various features of the mobile phone 16. Similarly, the keypad 36 may be conventional in that it provides for a variety of user input operations. For example, the keypad 36 typically includes alphanumeric keys for allowing entry of alphanumeric information such as telephone numbers, phone lists, contact information, notes, etc. In addition, the keypad 36 typically includes special function keys such as a “call send” key 38 for initiating or answering a call, and a “call end” key 40 for ending, or “hanging up” a call. Special function keys may also include menu navigation keys 42a , 42b and 42c , for example, for navigating through a menu displayed on the display 34 to select different phone functions, profiles, settings, etc., as is conventional. Other keys included in the keypad 36 may include a volume key (not shown), on/off power key (also not shown), as well as various other keys such as a web browser launch key, camera key, etc.

The mobile phone keypad 36 also includes a “hold” function key 44 for placing a call on hold. As is well known, sometimes the user of the mobile phone 16 desires to place the party or parties at the other end of a call on hold. By placing a call on “hold”, the called/calling device(s) at the other end of a conventional voice call do not receive audio from the user's mobile phone 16. In the case of a video phone call in which both audio and video signals are exchanged between the user's mobile phone 16 and the called/calling device(s), by placing a call on “hold” at least one or both of the audio and video from the user's mobile phone 16 is not sent to the called/calling device(s). In other words, the called/calling device(s) either receive video but no audio from the user's mobile phone 16; receive audio but no video; or do not receive audio or video.

In the embodiment of FIG. 1A the mobile phone 16 includes a dedicated “hold” function key 44 that toggles a call between “on hold” and “off hold”. Alternatively, the mobile phone 16 may associate more than one function with a given key on the keypad 36. For example, mobile phones commonly have a hold feature associated with the “call send” key 38. When making a call, the user enters a phone number and presses the “call send” key 38. When receiving an incoming call, the “call send” key 38 may be programmed to act as a “call answer” key. When participating in a call, the “call send” key 38 may serve as a “call hold” key for placing the call on hold. A user may wish to place a call on hold for any of a variety of known reasons. For example, the user may be on a call when another incoming call arrives. By pressing a dedicated hold key 44 the user may place the current call on hold and then answer the new incoming call. Alternatively, in the case of a multifunctional hold key the user may press the “call send” key 38 once to place the current call on hold and a second time to answer the new incoming call.

Those having ordinary skill in the art will appreciate that the particular mechanism utilized by a user to place a call on hold is not germane to the invention. The mobile phone 16 simply requires a means for allowing a user to place a call on hold. The specific form or format of the key(s) for placing a call on hold is not intended to limit the scope of the invention.

In the particular embodiment of FIG. 1A, the mobile phone 16 includes the display 34 and separate keypad 36. In an alternative embodiment, the display 34 may comprise a touchscreen which itself includes one or more keys. In yet another embodiment, the display 34 may comprise a touchscreen that includes all or substantially all of the keys used to operate the phone 16 so as to include a very limited keypad 36 or no keypad 36 at all. As will be appreciated, the particular form and function of the keys included in the keypad 36 or touchscreen/display 34 are not germane to the invention in its broadest sense.

The features of the present invention are described herein in the context of a mobile phone 16 suitable for carrying out video phone calls. For example, a video of a person at the called/calling device is transmitted over the communications network 10 and displayed by the mobile phone 16 of the user in accordance with the present invention. Similarly, the called/calling device will display a video of the user of the mobile phone 16. As is known, the mobile phone 16 is capable of sending and receiving video as well as audio during a call with a called/calling device. Moreover, the mobile phone 16 is capable of participating in video conference calls as is known. The particular technologies for communicating audio and video in both conference call and non-conference call settings are considered conventional. Accordingly, a detailed description of such technologies has been omitted for sake of brevity. On the other hand, many of the features of the present invention may be enjoyed even simply with traditional voice communications. In the broadest sense, the present invention is not intended to be limited in scope to any particular form of communications, e.g., whether audio and/or video.

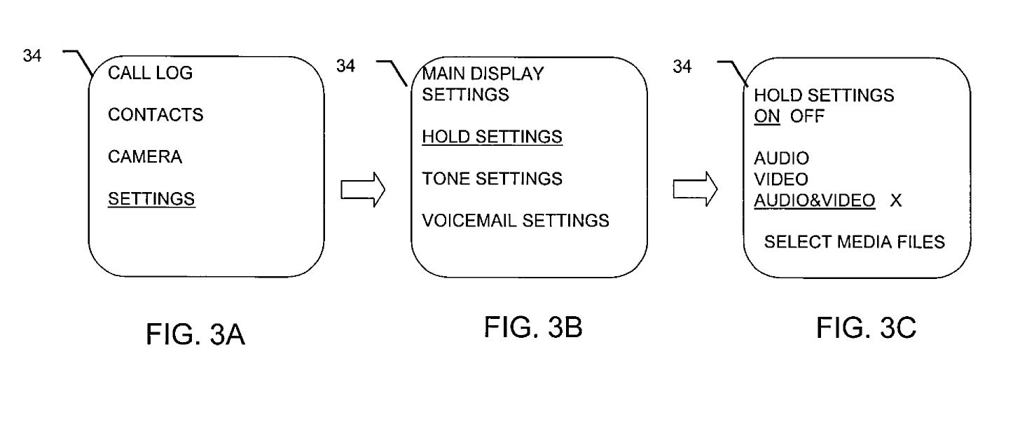

FIG. 1B illustrates a mobile phone 16, but in this case the mobile phone 16 constitutes the called/calling device at the other end of a call with a user's mobile phone 16 in accordance with the present invention. FIG. 1B represents circumstances whereby the user's mobile phone 16 has placed a call on hold. As is described below with respect to FIG. 4, the user may place a call on hold by pressing the hold key 44 or otherwise. The mobile phone 16 responds by muting the audio from the microphone and, in the case of a video call, the video also (if desired) from the mobile phone camera. In place of the audio and video normally sent, the user's mobile phone 16 communicates a media object preselected by the user to the called/calling device. The audio portion of the media object is communicated in place of the voice portion of the call and the video portion of the media object is transmitted in place of the video portion of the call. In the exemplary embodiment of FIG. 1B, the user's mobile phone 16 provides a media object including audio such as a song preselected by the user of the mobile phone 18 whom is requesting the hold. The audio is reproduced by the mobile phone through the speaker 46 as shown, for example. In addition, the visual portion of the media object, such as one or more still images or a video, is shown on the display 34. As a consequence, when the user of the mobile phone 16 places a call on hold, the mobile phone 16 of the party at the other end of the call will be able to enjoy the audio and/or video images provided by the user's mobile phone 16. Thus, the audio and video becomes an extension of the personality of the user of the mobile phone 16 that placed the call on hold. As is shown in FIG. 1B, the display 34 also may display a small “On Hold” message to visually indicate that the call has been placed on hold.

FIG. 1C illustrates another embodiment of the invention whereby the mobile phone 16 at the other end of the call placed on hold receives and reproduces a form of corporate logo or other type advertisement provided via a media object from the mobile phone 16 of the user. For example, FIG. 1C represents a brief commercial video displayed on the display 34 together with commercial jingle reproduced via the speaker 46. Thus, sales professionals are able to provide callers on the other end a brief promotion while they place a call on hold.

FIG. 1D illustrates a simple embodiment whereby a media object containing only an audio portion is provided to the called/calling device by the mobile phone 16 of the user.

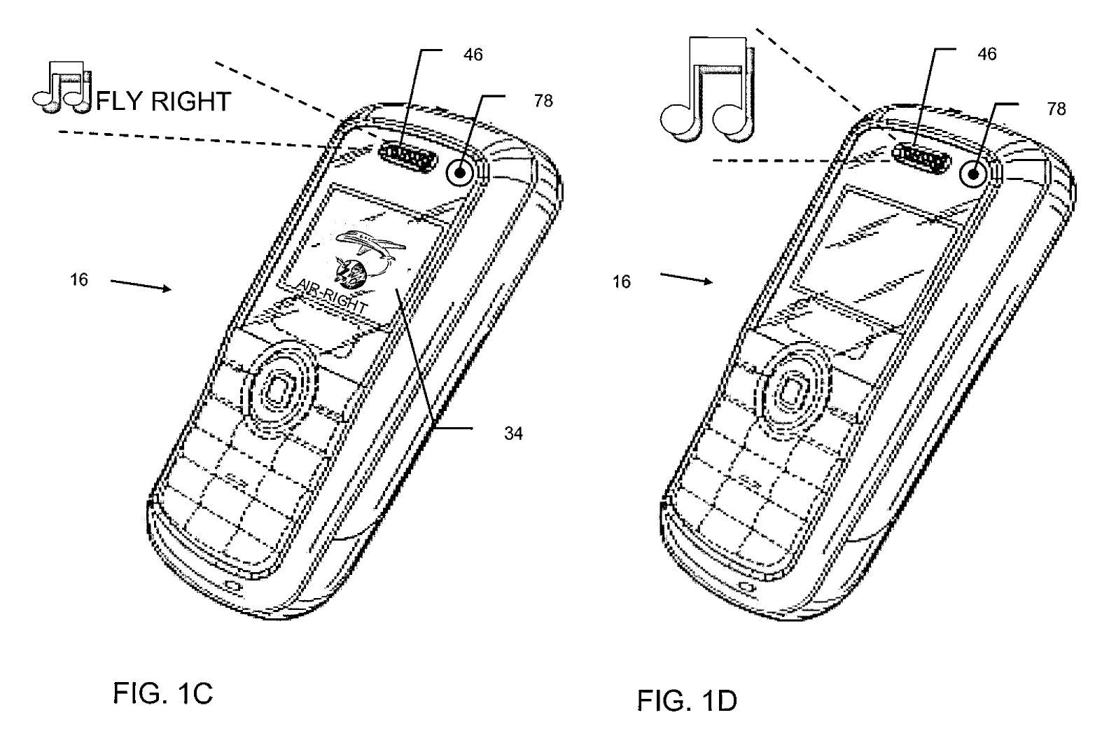

FIG. 2 represents a functional block diagram of the mobile phone 16 of the user in accordance with the invention. The construction of the mobile phone 16 is generally conventional with the exception of the hold functions described herein. Preferably, the hold functions are implemented primarily via application software within the mobile phone 16. However, it will be apparent to those having ordinary skill in the art that such operation can be carried out via primarily software, hardware, firmware, or combinations thereof, without departing from the scope of the invention.

The mobile phone 16 includes a primary control circuit 48 that is configured to carry out overall control of the functions and operations of the mobile phone 16. The control circuit 48 may include a CPU, microcontroller, or microprocessor, etc., collectively referred to herein simply as a CPU 50. The CPU 50 executes code stored in memory within the control circuit 48 (not shown) and/or in a separate memory 52 in order to carry out conventional operation of the mobile phone functions 54 within the mobile phone 16. In addition, however, the CPU 50 executes code stored in the memory 52 in accordance with the present invention in order to perform a hold function 56 and media player function 58.

As is explained in more detail below, the hold function 56 enables a user of the mobile phone 16 to place a call on hold. As a result of placing the call on hold, the hold function 56 serves to send a media object or objects to the called/calling devices at the other end of the call. Moreover, the hold function 56 enables the user to take the call off hold so as to stop the transfer of the media object(s) and resume conventional communications.

The media player function 58 serves to play media objects stored within the mobile phone 16 as is conventional. In addition, however, the media player function 58 may be used to provide the media object(s) to the called/calling devices at the other end of a call when the call is placed on hold. As will be discussed in detail below, the mobile phone 18 may communicate a media object to a called/calling device during a held call by any of a variety of known communication techniques. Some may include using the media player function 58 to reproduce a media object and communicate the audio and video via the mobile phone 16 using the voice and video portions of the existing call in place of the voice and video ordinarily provided during the call. Alternatively, the media player function 58 may instead simply serve as a means for transferring a media object file to the called/calling device using conventional file transfer techniques. As a particular example, the media object player function may serve to stream the media object to the called/calling device using conventional media streaming techniques.

The mobile phone 16 preferably includes a media library 62. The media library 62 represents a storage medium that stores various media objects in the form of audio files, video files, picture/image files, etc. that the user may select from to communicate to a called/calling device during a held call. The media objects may include different songs, advertisements, music videos, personal videos, promotional videos, etc. The storage medium making up the media library 62 preferably is a non-volatile memory such as a large capacity flash memory or micro-hard drive, each of which are well known in personal media players. In a more limited context, the media library 62 may be represented by a relatively small capacity compact disk (CD), mini-disk, flash card, etc., each of which may be inserted into the mobile phone 16 for reproduction of the media objects thereon. Alternatively, media object(s) also may reside on remote storage. For example, the media objects may reside on a remote server also accessible by the mobile phone 16 via a wireless Internet connection.

A person having ordinary skill in the art of computer programming and specifically in applications programming for mobile phones will consider it obvious in view of the description provided herein how to program a mobile phone 16 to operate and carry out the functions described herein. Accordingly, details as to the specific programming code have been left out for sake of brevity. Also, while the hold function 56 is carried out via the CPU 50 and application software in the memory 52 in accordance with a preferred embodiment of the invention, such functions could also be carried out via dedicated hardware, firmware, software, or combinations thereof, without departing from the scope of the invention.

Continuing to refer to FIG. 2, the mobile phone 16 includes an antenna 64 coupled to a radio circuit 66. The radio circuit 66 includes a radio frequency transmitter and receiver for transmitting and receiving signals via the antenna 64 as is conventional. The mobile phone 16 further includes an audio processing circuit 68 for processing the audio signal transmitted by/received from the radio circuit 66. In addition, the audio processing circuit 68 serves to process the audio signal provided by the control circuit 48 during playback of media objects. Coupled to the audio processing circuit 68 are the aforementioned speaker 46, and a microphone 70 which enable a user to listen and speak via the mobile phone 10 as is conventional. In addition, a headphone jack 72 coupled to the audio processing circuit 68 is provided. This allows a headset to be connected to the mobile phone 16.

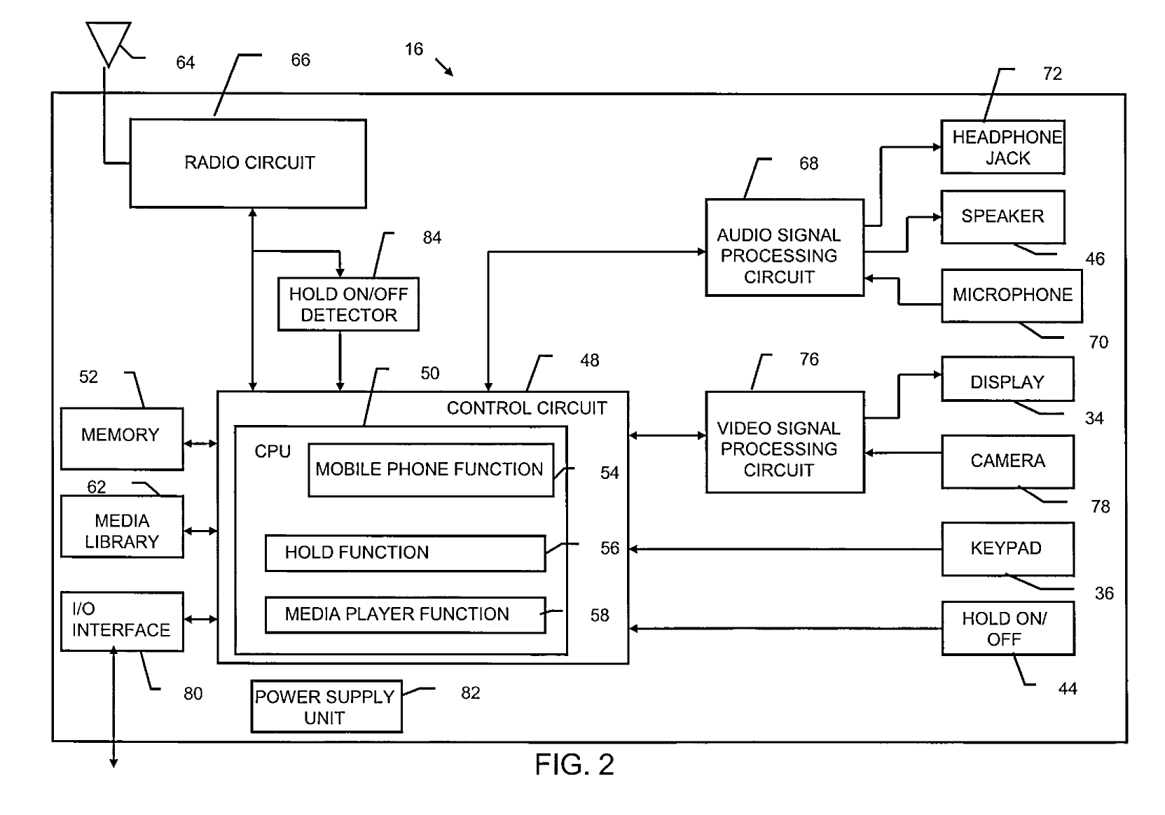

The mobile phone 16 also includes a video signal processing circuit 76 as shown in FIG. 3. The video signal processing circuit allows the mobile phone 16 to reproduce media objects including images and/or videos on the display 34. Moreover, the video signal processing allows a still images and/or videos from the mobile phone 16 to be captured via a camera 78 included in the phone 16. The camera 78 is preferably mounted on the face of the mobile phone 16 as shown in FIGS. 1A thru 1D so as to be capable of capturing an image of the user. During video calls, the camera 78 captures an image that is then communicated along with the audio to the called/calling device(s) on the other end of the call.

The mobile phone 16 also includes the aforementioned display 34, keypad 36, and specifically the “hold key” 44, coupled to the control circuit 48. The mobile phone 16 further includes an I/O interface 80. The I/O interface 80 may be in the form of any one of many typical mobile phone I/O interfaces, such as a multi-element connector at the base of the mobile phone 16. As is typical, the I/O interface 80 may be used to couple the mobile phone 16 to a battery charger to charge a power supply unit 82 within the mobile phone 10. In addition, or in the alternative, the I/O interface 80 may serve to connect the mobile phone 16 to a wired personal hands-free adaptor (not shown) or Bluetooth adaptor (also not shown) for use with a Bluetooth-based hands-free adaptor. Further, the I/O interface 80 may serve to connect the mobile phone 16 to a personal computer or other device via a data cable, etc. As another alternative, the I/O interface 80 may serve to connect the mobile phone 16 to a docking station including an audio amplifier, speakers and/or video display to allow for enhanced viewing/listening of the media objects as part of the media player function.

Additionally, the mobile phone 16 may include an optional hold on/off detector 84. The hold on/off detector 84 is designed to detect whether voice information to or from a called/calling device is being received/transmitted by the mobile phone 16. For example, the hold on/off detector 84 monitors the voice signal received from/transmitted to the called/calling device via the radio circuit 66. If the voice signal does not exceed a predetermined amplitude threshold for over a predefined period (e.g., 3 seconds), the hold on/off detector 84 is designed to detect such silence as indicative of the call being on hold. Alternatively, if the hold on/off detector 84 does detect a voice signal to or from the called/calling device in excess of the predetermined amplitude, the hold on/off detector 84 considers the call not to be on hold. Thus, if the user of the mobile phone 18 does not place the call on hold but there is silence on the call for over a predefined period (e.g., 3 seconds), the hold on/off detector 84 determines that the user of the called/calling device has placed the call on hold. Otherwise, the hold on/off detector 84 considers the call not to be on hold. The hold on/off detector 84 provides a corresponding control signal to the control circuit 48.

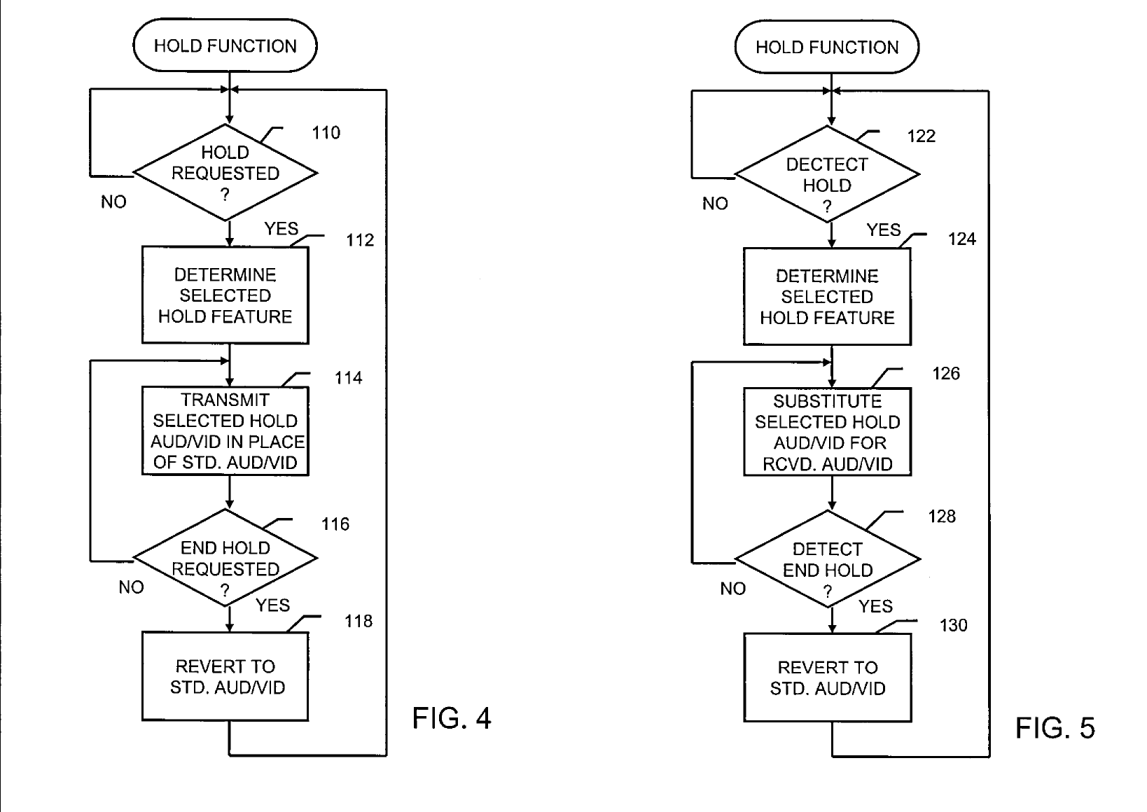

As will be explained in more detail below in accordance with FIG. 5, the hold on/off detector 84 is operative in conjunction with the media player function 58 to provide the user of the mobile phone 18 with entertainment via a song, video, etc. during such time as the called/calling device at the other end places the call on hold. The hold on/off detector 84 may be implemented via hardware, software, firmware, or a combination thereof, as will be appreciated.

Referring now to FIGS. 3A, 3B and 3C, an exemplary user interface presented on the display 34 is shown illustrating how a user may make appropriate selections in accordance with the invention. Suppose the user of the mobile phone 16 wishes to activate the call hold functions of the present invention. The user may press a menu button on the mobile phone 16 and be presented with the display of menu selections as represented in FIG. 3A. The user may selection the “Settings” selection in order to proceed to the next menu as represented in FIG. 3B. In FIG. 3B, the user is presented with the option of adjusting the “hold settings”. By selecting “hold settings”, the user is then presented with the display represented in FIG. 3C. The user may then customize the hold settings using conventional principles as used with respect to selecting ring tones, wallpaper, etc. For example, FIG. 3C illustrates how the user is presented with the option of turning the call hold features on or off. In addition, the user can select whether the media objects delivered to the called/calling devices at the other end of a held call receive audio, video, or combined audio and video objects.

The user of the mobile phone 16 may also select personalized media files as represented in FIG. 3C. Although not shown, the user may select particular songs, personal videos, advertisements, promotional videos, etc. to be communicated to the called/calling devices at the other end of a held call. In the case of calls placed on hold by the called/calling devices, the user may select particular songs, personal videos, etc. to be reproduced within the mobile phone 18 itself. Moreover, the user may select to input different criteria to be used in conjunction with the selection of the particular media objects to be communicated to the called/calling devices. For example, the user may be presented with an option to associate specific media objects (e.g., songs) based on the identification of the called/calling party. Alternatively, the user may be presented with an option to randomly select media objects to be communicated, for example.

Turning now to FIG. 4, the process of carrying out a hold function from the perspective of a user's mobile phone 16 in accordance with the present invention will now be described. Initially, it is assumed that the user is engaged in a call between the user's mobile phone 16 and one or more called/calling devices. Such standard call or conference call is established using conventional techniques within a network. Beginning in step 110, the CPU 50 of the mobile phone 16 determines if the user has requested that the call be placed on hold. The CPU 50 may detect whether the user has requested that the call be placed on hold by way of, for example, the user pressing the hold function key 44. If a hold request has not been detected, the CPU 50 will continue to loop around step 110 as shown in FIG. 4.

If the user has requested that the call be placed on hold as determined in step 110, the process proceeds to step 112. In step 112, the CPU 50 determines the particular media object or objects that are to be communicated to the called/calling device based on the user's selections as discussed above in relation to FIGS. 3A-3C. Again, for example, the user may request that the particular media object to be communicated to the called/calling device be based on the identity of the called/calling party. Based on such information as the user's selections, the identification of the called/calling party, etc., the CPU 50 determines the particular media objects to be communicated.

The CPU 50 proceeds to step 114 in which the media object is communicated to the called/calling devices in place of the standard audio and video from the microphone 70 and camera 78, respectively. More particularly, the CPU 50 obtains the selected media object(s) from the media library 62. The CPU 50 then proceeds to transmit the audio and/or video to the called/calling devices in place of the standard audio and/or video as represented in step 114. The CPU 50 can transmit the media object in any suitable manner. For example, in the case of video it is preferable to stream the audio and video data to the called/calling devices via the media player function 58 to reduce bandwidth requirements. Alternatively, if the bandwidth is available the CPU 50 may simply reproduce the audio and/or video via the media player function 58 and feed it to the called/calling devices in real time in place of the standard audio and/or video from the user's mobile phone 16.

In step 116, the CPU 50 determines if the user has requested that the call be taken off hold. If no, the CPU 50 continues to loop through step 114 and continues to communicate the media object(s) to the called/calling devices. Whether the user has requested that the call be taken off hold can be determined based on the user pressing the hold function key 44 a second time, for example. Upon detecting that the user has requested that the call be taken off hold, the CPU 50 proceeds to step 118 in which the CPU 50 stops communicating the media object to the called/calling devices. In step 118, the CPU 50 causes the mobile phone 16 to revert back to standard audio and/or video communications between the user's mobile phone 16 and the called/calling devices. As a result, the mobile phone 16 returns to conventional operation whereby audio and video from the mobile phone 16 continues to be transmitted to the called/calling devices as in a conventional call. In addition, the CPU 50 returns to step 110.

Accordingly, the person at the other end of a call placed on hold is able to listen and/or watch a media object personally selected by the user of the mobile phone 16. Thus, the personality of the user extends beyond the mobile phone 16 itself, resulting in enhanced enjoyment.

FIG. 5 illustrates a hold feature of the invention whereby the user of the mobile phone 16 itself is entertained by selected media object(s) when the called/calling device is determined to have placed the call on hold. Again, it is assumed that a call between the user's mobile phone 16 and a called/calling device or devices has already been established. Beginning in step 122, the CPU 50 determines if a call has been placed on hold via the output of the hold on/off detector 84 as discussed above. If a call hold has not been detected, the CPU 50 simply continues to loop around step 122 as shown. If a call hold is detected in step 122, the CPU 50 proceeds to step 124. The CPU 50 in step 124 determines the particular media object or objects the user selected to be reproduced during the held call. Such determination again may be based on the user's selections as discussed above in relation to FIGS. 3A-3C. Similar to the above case where the media objects are communicated to the called/calling devices, the user may request that the particular media object to be reproduced be based on the identity of the called/calling party. Based on such information as the user's selections, the identification of the called/calling party, etc., the CPU 50 determines the particular media objects to be reproduced.

Following step 124, the CPU 50 proceeds to step 126 in which the CPU 50 obtains the selected media object(s) from the media library 62. The CPU 50 then proceeds to reproduce the audio and/or video of the reproduced media object for the benefit of the user via the media player function 58, speaker 46 and display 34 of the mobile phone 16. The CPU 50 provides the reproduced audio and/or video to the speaker 46 and display 34 in place of the standard audio and/or video otherwise received from the called/calling devices. Accordingly, the user of the mobile phone 16 will be entertained by his or her own personal selections when placed on hold.

In step 128, the CPU 50 determines if the call hold has ended as represented by the output of the hold on/off detector 84 discussed above. If not, the CPU 50 continues to loop through step 126 and the mobile phone 16 continues to entertain the user with the selected media objects. If the call hold ends as determined in step 128, the CPU 50 proceeds to step 130 in which the CPU 50 causes the mobile phone 16 to revert back to conventional operation. As a result, audio and video from the mobile phone 16 continues to be transmitted to the called/calling devices as in a conventional call. In addition, the CPU 50 returns to step 122.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. An electronic equipment, comprising:
call circuitry that enables the electronic equipment to establish a call with a called/calling device;
hold circuitry that enables the electronic equipment to place the call established with the called/calling device on hold;
a media player; and
a controller operative in conjunction with the call circuitry, hold circuitry and media player to communicate a media object to the called/calling device when the call is placed on hold.

2. The electronic equipment of claim 1, wherein the media player streams the media object to the called/calling device.

3. The electronic equipment of claim 1, wherein the media player reproduces the media object as an audio signal when communicating the media object to the called/calling device.

4. The electronic equipment of claim 1, further comprising a library of media objects, and the controller enables a user to select from the library the media object communicated to the called/calling device.

5. The electronic equipment of claim 1, further comprising a library of media objects, and the controller communicates the media object selected from among the library of media objects as a function of an identity of the called/calling device.

6. The electronic equipment of claim 1, further comprising a library of media objects, and the controller communicates the media object selected generally randomly from among the library of media objects.

7. The electronic equipment of claim 1, wherein the media object comprises an audio object.

8. The electronic equipment of claim 1, wherein the media object comprises a visual object.

9. The electronic equipment of claim 1, wherein the media object represents an advertisement.

10. An electronic equipment, comprising:
call circuitry that enables the electronic equipment to establish a call with a called/calling device;
hold detection circuitry that enables the electronic equipment to detect if the call established with the called/calling device has been placed on hold;
a media player;
at least one of an audio output and a display; and
a controller operative in conjunction with the call circuitry, hold detection circuitry and media player to reproduce a media object via the at least one of the audio output and the display when the call is detected as having been placed on hold.

11. The electronic equipment of claim 10, further comprising a library of media objects, and the controller enables a user to select from the library the media object which is reproduced.

12. The electronic equipment of claim 10, further comprising a library of media objects, and the controller selects the media object that is reproduced from among the library of media objects as a function of an identity of the called/calling device.

13. The electronic equipment of claim 10, further comprising a library of media objects, and the controller selects the media object which is reproduced generally randomly from among the library of media objects.

14. The electronic equipment of claim 10, wherein the media object comprises an audio object.

15. The electronic equipment of claim 10, wherein the media object comprises a visual object.

16. A computer program stored on a machine-readable medium for use in conjunction with an electronic equipment comprising call circuitry that enables the electronic equipment to establish a call with a called/calling device; hold circuitry that enables the electronic equipment to place the call established with the called/calling device on hold; and a media player, wherein the computer program upon execution by a controller is operative in conjunction with the call circuitry, hold circuitry and media player to at least one of communicate a media object to the called/calling device when the call is placed on hold, and reproduce a media object via at least one of an audio output and a display when the call is detected as having been placed on hold.
